(19) United States
(12) Patent Application Publication
(10) Pub. No.: US 2009/0063652 A1
(43) Pub. Date: Mar. 5, 2009

(54) Localized Media Content Delivery

(76) Inventors: Yoon Sub Hwang, Alameda, CA (US); Ellis M. Verosub, San Carlos, CA (US); Payam Mirrashidi, San Francisco, CA (US); Patrice Gautier, San Francisco, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 11/849,718

(22) Filed: Sep. 4, 2007

(51) Int. Cl. G06F 15/16

(52) U.S. Cl. 709/213

(57) ABSTRACT

Improved approaches to make data available locally at business establishments are disclosed. In one embodiment, data anticipated to be soon to be requested by patrons of a particular business establishment can be pre-loaded to a local server provided at the particular business establishment. By pre-loading data that is anticipated to be soon to be requested by patrons of the particular business establishment, local network access traffic and congestion at the retail establishment can be reduced. The improved approaches are particularly well suited for media content data that is likely to be requested by patrons at business (e.g., retail) establishments. Advantageously, patrons can get rapid download of media content data associated with one or more media items that the patrons have purchased from an online media store.

### BACKGROUND OF THE INVENTION

1. Field of the Invention

The present invention relates to media content delivery and, more particularly, to localized media content delivery for improved responsiveness. Description of the Related Art

Today, Internet access is facilitated by data centers that provide geographically distributed servers that can provide caching and content delivery services. Akamai Technologies, Inc. of Cambridge, Mass. is one large data center service provider that represents that it has a distributed computing environment with more than 25,000 servers deployed in at least 60 countries. The objective of such data centers is replicate content so as to be able to deliver content from the edges of the Internet.

Establishments or businesses normally couple to the Internet by way of a leased line, such as a T1 line. When the resources (available bandwidth) of the leased line are shared by the various users at the establishments or businesses, the load on the leased line can be significant. As a result, the users accessing the Internet can experience localized congestion and traffic across the leased line. Consequently, Internet browsing and e-commerce at establishments or businesses can be hindered due to network access delay. Moreover, in the case of e-commerce activity with respect to media items, such as downloading digital media assets, the amount of data transfer involved tends to be relatively large which compounds the traffic and congestion imposed on the leased line.

Thus, there is a need for improved approaches to manage consumption of a shared network access resource.

### SUMMARY OF THE INVENTION

The invention pertains to improved approaches to make data available locally at business establishments. In one embodiment, data anticipated to be soon to be requested by patrons of a particular business establishment can be pre-loaded to a local server provided at the particular business establishment. By pre-loading data that is anticipated to be soon to be requested by patrons of the particular business establishment, local network access traffic and congestion at the retail establishment can be reduced. The invention is particularly well suited for media content data that is likely to be requested by patrons at business (e.g., retail) establishments. Advantageously, patrons can get rapid download of media content data associated with one or more media items that the patrons have purchased from an online media store.

The invention can be implemented in numerous ways, including as a method, system, device, or apparatus (including computer readable medium). Several embodiments of the invention are discussed below.

As a method for preloading media content at a retail location, one embodiment of the invention includes at least the acts of: determining whether a cache server placed at a retail location should be updated; determining a set of media items that are to be preloaded on the cache server at the retail location; identifying network location of media content for each of the media items in the determined set of media items that are to be preloaded on the cache server at the retail location; retrieving media content for each of the media items at the network location corresponding thereto; and storing the retrieved media content on the cache server at the retail location it is determined that the cache server at the retail location is to be updated.

As a computer readable medium including at least executable computer program code tangibly stored thereon for preloading media content at a business location, one embodiment of the invention includes at least: computer program code for determining whether a cache server placed at a business location should be updated; computer program code for determining a plurality of digital media assets that are to be preloaded on the cache server at the business location; computer program code for identifying a network location of media content for each of the digital media assets in the determined plurality of digital media assets that are to be preloaded on the cache server at the business location; computer program code for retrieving media content for each of the digital media assets at the network location corresponding thereto; and computer program code for storing the retrieved media content on the cache server at the business location when it is determined that the cache server at the business location is to be updated.

As a media content delivery system, one embodiment of the invention includes at least: a store cache server provided at a retail environment; a media content preload manager operable to preload media content pertaining to a determined set of media items onto the store cache server; and a central server coupled to at least one data network, the central server being remote from the retail store, and the central server being configured to determine the set of media items for which media content is to be preloaded onto the store cache server.

As a media content delivery system, one embodiment of the invention includes at least: a store cache server provided at a retail environment; a media play system at the retail environment, the media play system configured to play media content pertaining to one or more media items, the media play system being configured to play a sequence of media items; and a media content preload manager operable to preload media content pertaining to the sequence of media items onto the store cache server.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a media delivery system according to one embodiment of the invention.

FIG. 2 is a flow diagram of a store-based caching process according to one embodiment of the invention.

FIG. 3 is a block diagram of a media delivery system according to one embodiment of the invention.

FIG. 4A is a diagram of an exemplary store playlist according to one embodiment of the invention.

FIG. 4B is a diagram of an exemplary top media item list according to one embodiment of the invention.

### DETAILED DESCRIPTION OF THE INVENTION

The invention pertains to improved approaches to make data available locally at business establishments. In one embodiment, data anticipated to be soon to be requested by patrons of a particular business establishment can be pre-loaded to a local server provided at the particular business establishment. By pre-loading data that is anticipated to be soon to be requested by patrons of the particular business establishment, local network access traffic and congestion at the retail establishment can be reduced. The invention is particularly well suited for media content data that is likely to be requested by patrons at business (e.g., retail) establishments. Advantageously, patrons can get rapid download of media content data associated with one or more media items that the patrons have purchased from an online media store.

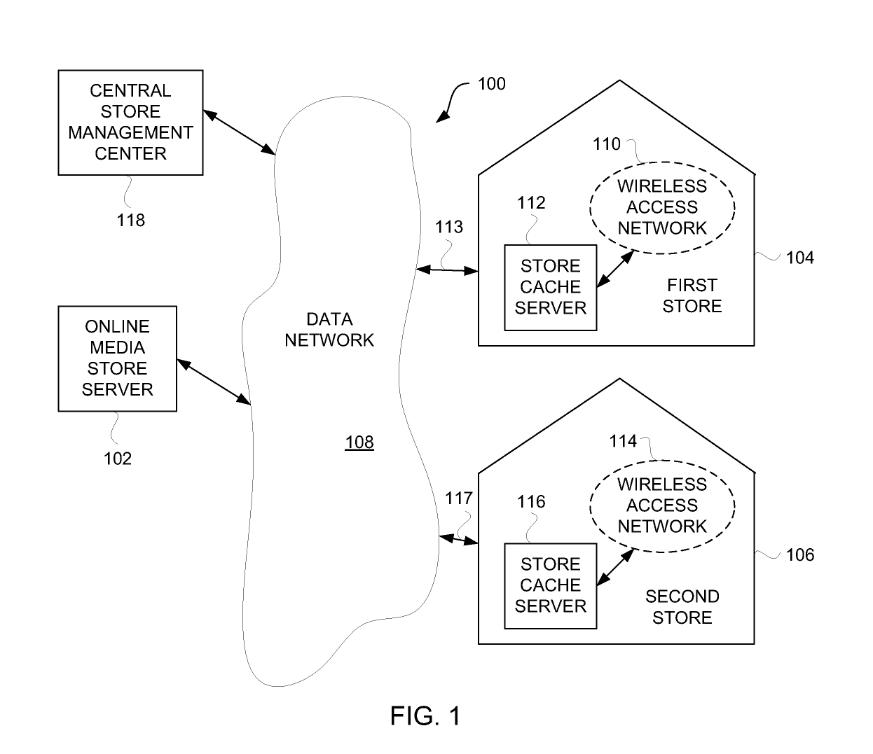

Embodiments of the invention are discussed below with reference to FIGS. 1-4B. However, those skilled in the art will readily appreciate that the detailed description given herein with respect to these figures is for explanatory purposes as the invention extends beyond these limited embodiments.

FIG. 1 is a block diagram of a media delivery system 100 according to one embodiment of the invention. The media delivery system 100 includes an online media store server 102. The online media store server 102 hosts an online media store that can be accessed over a network. The online media store can offer digital media assets (e.g., media items) for purchase, rental, preview, etc. One example of an online media store is iTunes® media store operated by Apple Inc. of Cupertino, Calif. The media delivery system 100 also includes network and storage equipment at one or more stores, such as a first store 104 and a second store 106. The first store 104 and the second store 106 couple to a data network 108. The online media store server 102 also couples to the data network 108. The data network 108 can include one or more networks, which can be not only public or private but also wired or wireless.

In the first store 104, a wireless access network 110 is provided so that patrons of the first store 104 can gain wireless access to the data networks 108 while residing within the first store 104. The first store 104 also includes a store cache server 112. The store cache server 112 operates as a networked cache memory storage device resident within the first store 104. The store cache server 112 couples to the wireless access network 110 and can also couple to the data network 108 over a network link 113 (directly or indirectly through the wireless access network 110). The wireless access network 110 can, for example, by a local area wireless network generally associated with the first store 104. One specific example of a local area wireless network is a WiFi network. The network link 113 is a shared network access resource, such as a lease line (e.g., T1 line) to the data network. Accordingly, patrons to the first store 104 that have a portable electronic device that supports wireless communication are able to communicate with the online media store server 102 by way of the data network 108 and the wireless access network 110. In doing so, the patron may purchase or otherwise acquire media content pertaining to a media item that is offered for acquisition (e.g., purchase, rental, etc.) by the online media store server 102. When the portable electronic device requests media content for such a media item, the media content is already resident within the store cache server 112. In such case, the media content can be delivered to the portable electronic device of the patron directly from the store cache server 112 via the wireless access network 110. As such, the requested media content is local to the first store 104 and it can be rapidly delivered to the portable electronic device of the patron without having to endue network delays of the data network 108 due to network traffic or congestion.

Similarly, in the second store 106, a wireless access network 114 is provided so that patrons of the first store 106 can gain wireless access to the data networks 108 while residing within the second store 106. The second store 106 also includes a store cache server 116. The store cache server 116 operates as a networked cache memory storage device resident within the second store 106. The store cache server 116 couples to the wireless access network 114 and can also couple to the one or more data networks 108 over a network link 117 (directly or indirectly through the wireless access network 114). Accordingly, patrons to the second store 106 that have a portable electronic device that supports wireless communication are able to communicate with the online media store server 102 by way of the data network 108 and the wireless access network 114. In doing so, the patron may purchase or otherwise acquire media content pertaining to a media item that is offered for acquisition (e.g., purchase, rental, etc.) by the online media store server 102. When the portable electronic device requests media content for such a media item, the media content is already resident within the store cache server 116. In such case, the media content can be delivered to the portable electronic device of the patron directly from the store cache server 116 via the wireless access network 114. As such, the requested media content is local to the second store 106 and it can be rapidly delivered to the portable electronic device of the patron without having to endue network delays of the data network 108 due to network traffic or congestion.

Additionally, the media delivery system 100 includes a central store management server 118. The central store management server 118 couples to the data network 108. As such, the central store management server 118 can communicate with the first store 104 or the second store 106 via the data network 108. In one embodiment, the central store management server 118 coordinates delivery of particular media content to the store cache server 112 for the first store 104 as well as delivery of particular media content to the second store 106. In doing so, the central store management server 118 can intelligently decide what media content is likely to be needed by patrons of the respective stores 104 and 106, and to cause such media content to be delivered to the store cache servers 112 and 116 in advance of it being needed. If desired, the central store management server 118 can cause different media content to be stored in the different store cache servers 112 and 116 respectively associated with the first store 104 and the second store 106.

Although the media delivery system 100 is illustrated in FIG. 1 as having the first store 104 and the second store 106, it should be understood that the media delivery system 100 is suitable for use with one or more stores. Typically, a particular retailer will have a plurality of retail stores in different geographical locations. With all of the stores coupled to the data network 108, such as a global public network, the central store management server 118 can manage in the media content to be cached in the respective store cache servers of any of the plurality of retail stores. Consequently, these various retails stores can be prepared to rapidly deliver media content for different media items that patrons of such store might likely request. For example, a patron may likely purchase a particular media item from the online media store while at the store, and then have the corresponding media content for the purchased media item rapidly delivered (i.e., downloaded) by way of a store cache server while the patron is at the retail store.

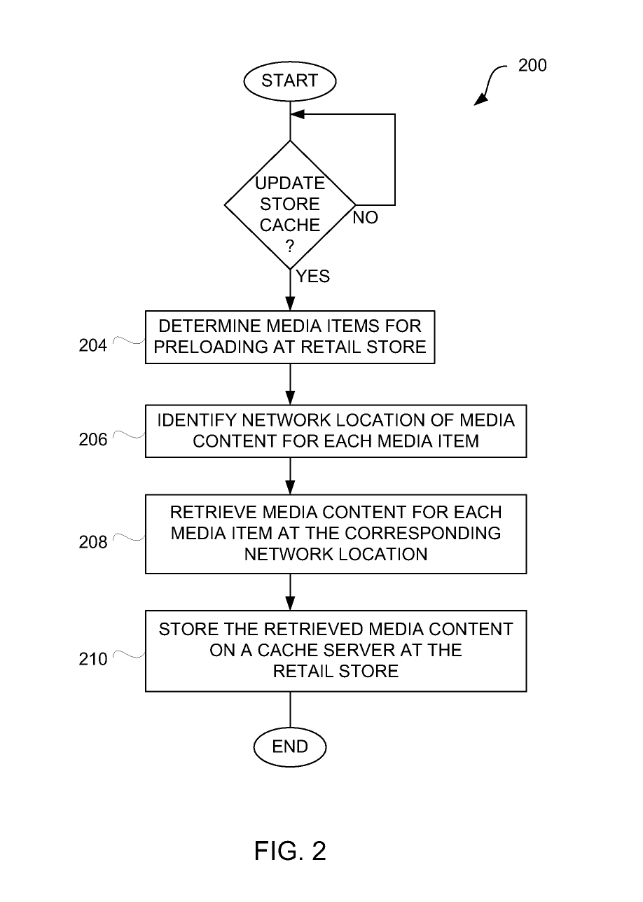

FIG. 2 is a flow diagram of a store-based caching process 200 according to one embodiment of the invention. The store-based caching process 200 is, for example, performed by a central store management server, such as the central store management server 118 illustrated in FIG. 1. However, it should be understood that the store-based caching process 200 can also be performed by another server, such as a store cache server, a regional cache server or a central retailer server.

The store-based caching process 200 can begin with a decision 202 that determines whether a store cache is to be updated. Here, it is assumed that a retail location (retail store), namely, a store, has a cache server (store cache server) that provides a store cache. When the decision 202 determines that the store cache is not to be updated, then the store-based caching process 200 awaits in the need to update a store cache.

On the other hand, when the decision 202 determines that the store cache is to be updated, media items to be preloaded at the retail location are determined 204. Next, a network location of media content for each of the determined media items can be identified 206. In one implementation, the network locations for the corresponding media content are known by an accessible server, such as the online media storage server 102. For example, in one embodiment, the central store management server 118 can request the network locations of media content for each of the determined media items from the online media store server 102, and the requested network locations can be returned from the online media store server 102 to the central store management server 118.

After the network locations have been identified 206, media content for each of the media items can be retrieved 208 at the corresponding network locations. The corresponding network locations are at one or more remote servers. In one embodiment, the remote server is a server within a data centers that provide geographically distributed servers that can provide caching and content delivery services (e.g., distributed cache system) that replicates (e.g., mirrors) at least a part of the media content made available by the online media store server 102. In any case, the retrieved media content can be stored 210 on the cache server at the retail store. Following the block 210, the store-based caching process 210 can end.

Additionally, it is noted that the decision 202 can determine whether a store cache is to be updated based on time-of-day. For example, in the late evening hours or early morning hours of the day, the retail store is closed. As such, the network access at the store is not in use by patrons so it is freely available to be utilized to retrieve media content via a network (e.g., data network 108) for storage to the cache server at the retail store. Hence, in one embodiment, the update to a store cache can be set or scheduled in accordance with a time-of-day.

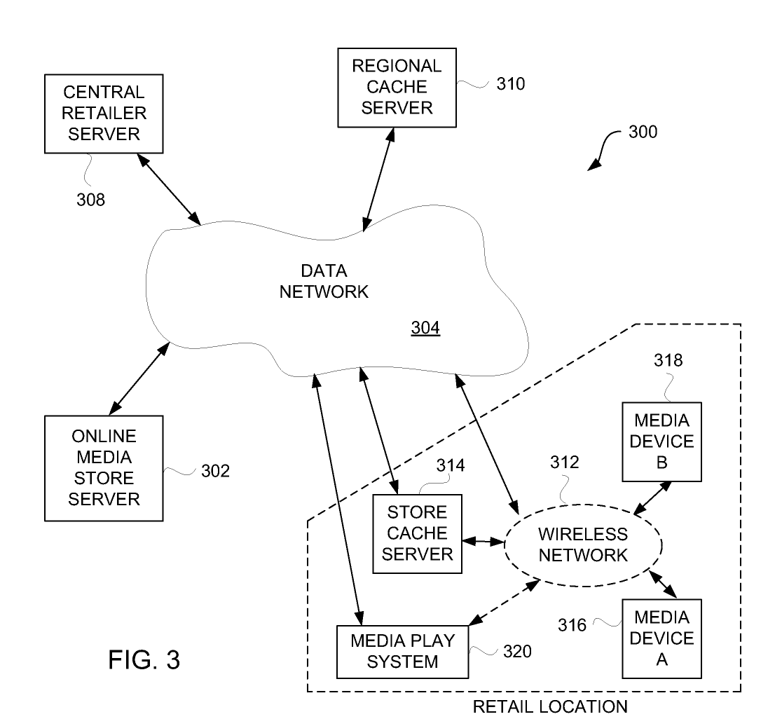

FIG. 3 is a block diagram of a media delivery system 300 according to one embodiment of the invention. The media delivery system 300 includes an online media store server 302 that couples to a data network 304. The data network 304 can include one or more networks, which can be not only public or private but also wired or wireless. The media delivery system 300 also includes equipment at a retail location 306, a central retailer server 308 and a regional cache server 310, each of which can also couple to the data network 304. Although the media delivery system 300 illustrates only a single retail location, namely, the retail location 306, it should be understood that the media delivery system 300 typically supports a plurality of different retail locations in different geographical locations.

The online media store server 302 hosts an online media store from which digital media assets can be acquired (e.g., purchased). On acquisition of a digital media asset, media content for the purchased digital media asset is delivered to the purchaser. More particularly, the media content is delivered to an electronic device (media device) associated with the user. Typically, the purchaser has interacted with the online media store server 302 from the retail location 306 using an electronic device, such as a portable electronic device. In such case, the media content for the digital media asset is delivered to the electronic device associated with the purchaser while residing at the retail location. The delivery system 300 operates to distribute media content to the retail location 306 in advance so that the media content is readily and locally available for delivery when purchased by a purchaser residing at the retail location 306.

The retail location 306 includes a wireless network 312 and a store cache server 314. The wireless network 312 and/or the store cache server 314 can coupled to the data network 304. Additionally, at the retail location 306, one or more media devices 316 and 318 can be coupled to the wireless network 312. Typically, the media devices 316 and 318 are portable electronic devices that are associated with persons visiting the retail location 306. When the media devices 316 and 318 are within the retail location 306, the electronic devices, assuming that they support wireless communications, are able to access the wireless network 312 associated with the retail location 306. As such, the media devices 316 and 318 are able to communicate to the online media store server 302 by way of the wireless network 312 and the data network 304. In the event that a user of one of the media devices 316 and 318 purchases is a digital media asset from the online media store server 302, the media content associated with the purchased digital media asset can be delivered to the media device 316 or 318 associated with the user directly from the store cache server 314. Here, the central retailer server 308 operates in advance to store to the store cache server 314 at the retail location 306 the likely required media content. Consequently, media content for a purchased digital media asset can be delivered locally at the retail location 306 from the store cache server 314 to the requesting media device 316 or 318 via the wireless network 312. As such, the delivery of the media content is not required to be requested and returned from a remote server by way of the data network 304 or a network access link thereto which can suffer from network traffic or congestion.

The retail location 306 can also support a media play system 320. The media play system 320 can also be coupled to the data network 304. By being coupled to the data network 304, the central retailer server 308 can operate to manage the operation of the media play system 320 at the retail location 306. In one embodiment, the media play system 320 operates to play media items at the retail location 306. For example, the media play system 320 can cause songs and/or videos to be played at the retail location 306 for the benefit of employees and patrons. The central retailer server 308 can centrally manage the media items that are to be played at the retail location 306. In one embodiment, the media items being played by the media play system 320 are media items that are also offered for purchase by the online media store server 302.

The networking components in the store location 306 can couple to the data network 304 via a network access link 322. The network access link 322 is a shared network access resource, such as a lease line (e.g., T1 line) to the data network 304. The wireless network 312, the store cache server 314 and the media play system 320 can access the data network 104 via the network access link 322.

As an example of one usage scenario, a user at the retail location 306 could hear a media item being played by the media play system 320 and elect to interact with the online media store server 302 to purchase the media item. As such, should a user of the media device 316 request to purchase such a media item from the online media store server 302 while at the retail location 306, the media content for the purchased media item can be directly delivered to the media device 316 from the store cache server 314 via the wireless network 312. In this case, it would have been required that the central retailer server 308 understand the future list of media items that will be played in the retail location 306 by the media play system 320 and also to cause the store cache server 314 to preload the media content associated with the media items on the list.

In one embodiment, the media content for the media items that are to be delivered and stored in the store cache server 314 can be made available from the regional cache server 310. The regional cache server 310 is remotely located from the retail location 306 but within a similar regional or metropolitan area as is the retail location 306. Hence, the delivery of the media content to the store cache server 314 can efficiently utilize the regional cache server 310 to offload or distribute server loads for media content delivery. The regional cache server 310 can also be referred to as an edge server.

As noted above, the central retailer server 308 can centrally manage the media items that are to be played at the retail location 306. However, in an alternative embodiment, the media items being played at the retail location 306 can be managed locally. In such case, the media play system 320 can be locally accessed to acquire information so that the store cache server 314 can be intelligently preloaded.

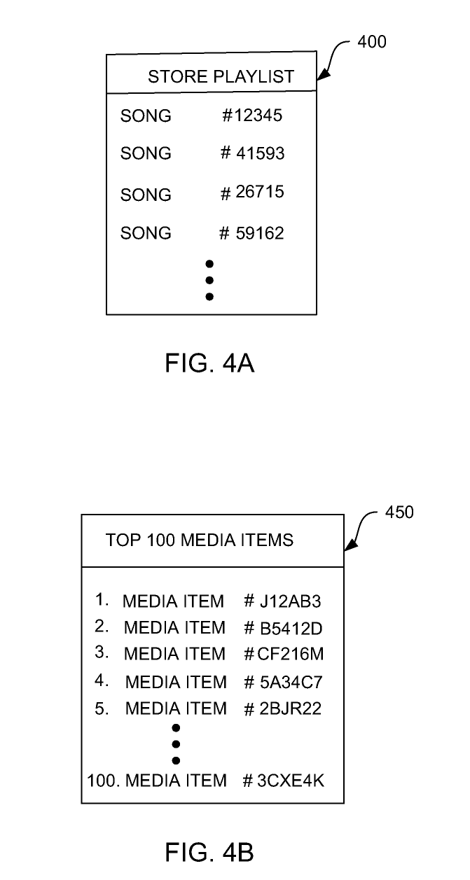

FIG. 4A is a diagram of an exemplary store playlist 400 according to one embodiment of the invention. The exemplary store playlist 400 can include a list of songs (audio tracks) that are to be presented at a particular store (retail location) on a given day. As illustrated in FIG. 4A, the exemplary store playlist 400 includes a plurality of specific songs that are identified by unique identifiers (e.g., song identifiers). A media play system at the particular store can be operated to sequentially play the songs on the exemplary store playlist 400. The store playlists can additionally or alternatively include music videos, movies and/or other media types.

FIG. 4B is a diagram of an exemplary top media item list 450 according to one embodiment of the invention. The exemplary top media item list 450 can include a list of those media items that are most popular. As illustrated in FIG. 4A, the exemplary top media item list 450 includes a plurality of specific media items that are identified by unique identifiers (e.g., media item identifiers). For example, the online media store may track its most popular media items for various types of digital media items. The exemplary top media item list 450 can pertain to a single type of media assets, such as songs (audio tracks). Alternatively, the exemplary top media item list 450 can pertain to multiple types of media assets, such as one or more of songs (audio tracks), music videos, videos (e.g., movies), podcasts, or audiobooks.

A media play system at a particular store can be operated to sequentially play the media assets identified in the exemplary store playlist 400 or the exemplary top media item list 450. However, the media play system can be configured or controlled to play only certain types of digital media assets. As noted above with reference to FIG. 3, the store cache server 314 can preload the media content associated with the media items on the exemplary store playlist 400 and/or the exemplary top media item list 450. The preloading of the exemplary store playlist 400 to the store cache server 314 renders media content for the media items being played at the retail location 306 readily available for local download. Similarly, the preloading of the exemplary top media item list 450 to the store cache server 314 renders media content for the top media items (from an online media store) readily available for local download at the retail location 306.

Retail locations or retail stores are, more generally, business locations or stores, respectively. Business locations or stores can also be referred to as business establishments. One type of business establishment is a retail establishment. Examples of business establishments include coffee/tea shops, new stands, gyms, electronic stores, media stores, food service stores, sporting goods stores, bars, etc. A group of businesses that are closely proximate to one another can also share network resources so as to effectively offer the same advantages. For example, a shopping mall can support all its individual business tenants in the mall by providing the network access and storage equipment throughout the shopping mall to be shared by the various business tenants.

The portable electronic device utilized herein can, for example, correspond to a computing device (e.g., personal computer), mobile phone (e.g., cellular phone), personal digital assistant (PDA), media player (e.g., music, videos, games, images), media storage device, camera, and/or the like. The electronic device may also be a multi-functional device that combines two or more of these device functionalities into a single device. In one embodiment, the portable electronic device should support wireless communications so that the portable electronic device can wirelessly couple to a local area wireless network.

The portable electronic device utilized herein can further be a hand-held electronic device. The term hand-held generally means that the electronic device has a form factor that is small enough to be comfortably held in one hand. A hand-held electronic device may be directed at one-handed operation or two-handed operation. In one-handed operation, a single hand is used to both support the device as well as to perform operations with the user interface during use. In two-handed operation, one hand is used to support the device while the other hand performs operations with a user interface during use or alternatively both hands support the device as well as perform operations during use. In some cases, the hand-held electronic device is sized for placement into a pocket of the user. By being pocket-sized, the user does not have to directly carry the device and therefore the device can be taken almost anywhere the user travels (e.g., the user is not limited by carrying a large, bulky and often heavy device).

The digital media assets (i.e., digital media items) can pertain to video items (e.g., video files or movies), audio items (e.g., audio files or audio tracks, such as for songs (music), podcasts or audiobooks), or image items (e.g., photos). The digital media assets can also include or be supplemented by text or multimedia files.

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different aspects, embodiments or implementations may, but need not, yield one or more of the following advantages. One advantage of the invention is that patrons of business establishments can rapidly download media content without being subject to network access congestion and traffic. Another advantage of the invention is that preloading of data for various business establishments can be centrally managed from a remote location. For example, a business having 100 distinct establishments (e.g., stores) can centrally, yet separately, control preloading of data for each of the establishments. Still another advantage of the invention is that a media content provider, such as an online media store, can coordinate with central management for various business establishments so that preloading of data for the business establishments can depend on statistical data available from the online media store. For example, the online media store can inform the central management of its most popular media items so media content for such media items can be preloaded at the business establishments.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for preloading media content at a retail location, said method comprising:
determining whether a cache server placed at a retail location should be updated;
determining a set of media items that are to be preloaded on the cache server at the retail location;
identifying network location of media content for each of the media items in the determined set of media items that are to be preloaded on the cache server at the retail location;
retrieving media content for each of the media items at the network location corresponding thereto; and
storing the retrieved media content on the cache server at the retail location when said determining determines that the cache server at the retail location is to be updated.

2. A method as recited in claim 1, wherein the retail location is a store.

3. A method as recited in claim 1, wherein the set of media items is a next day playlist to be played at the retail location.

4. A method as recited in claim 1, wherein said method further comprises:
subsequently receiving a request from a portable media device at the retail location for media content for at least one of the media items; and
delivering the media content for the at least one of the media items from the cache server at the retail location, whereby the media content resides in the cache server prior to said receiving of the request because it was stored there during said storing.

5. A method as recited in claim 1, wherein said method further comprises:
subsequently receiving a request at an online media store for media content for at least one of the media items, the request being from a portable media device at the retail location; and
delivering the media content for the at least one of the media items from the cache server at the retail location to the portable media device over a local wireless network, whereby the media content resides in the cache server prior to said receiving of the request because it was stored there during said storing.

6. A method as recited in claim 5, wherein the portable media device is a electronic device capable of communicating via the wireless network to the online media store.

7. A method as recited in claim 6, wherein the set of media items is a next day playlist to be played at the retail location.

8. A computer readable medium including at least executable computer program code tangibly stored thereon for preloading media content at a business location, said computer readable medium comprising:
computer program code for determining whether a cache server placed at a business location should be updated;
computer program code for determining a plurality of digital media assets that are to be preloaded on the cache server at the business location;
computer program code for identifying a network location of media content for each of the digital media assets in the determined plurality of digital media assets that are to be preloaded on the cache server at the business location;
computer program code for retrieving media content for each of the digital media assets at the network location corresponding thereto; and
computer program code for storing the retrieved media content on the cache server at the business location when it is determined that the cache server at the business location is to be updated.

9. A computer readable medium as recited in claim 8,
wherein the business location is a store,
wherein the plurality of digital media assets is a next day playlist to be played at the business location,
wherein said computer readable medium further comprises:
computer program code for receiving a request from a portable media device at the business location for media content for at least one of the digital media assets; and
computer program code for delivering the media content for the at least one of the digital media assets from the cache server at the business location, whereby the media content resides in the cache server because it was previously stored there by said computer program code for storing the retrieved media content on the cache server.

10. A media content delivery system, comprising:
a store cache server provided at a retail environment;
a media content preload manager operable to preload media content pertaining to a determined set of media items onto said store cache server; and
a central server coupled to at least one data network, said central server being remote from the retail store, and said central server being configured to determine the set of media items for which media content is to be preloaded onto said store cache server.

11. A media content delivery system as recited in claim 10, wherein said media content preload manager requests and receives a network location for each media item in the determined set of media items, the network locations being provided by an online media store server.

12. A media content delivery system as recited in claim 10, the network locations being associate with a cache store system coupled to the at least one data network.

13. A media content delivery system as recited in claim 12, wherein said media content preload manager retrieves the media content to be preloaded from the cache storage system using the network locations, and stores the received media content to the store cache server.

14. A media content delivery system as recited in claim 12, wherein the cache storage system includes at least a plurality of regional cache servers placed in different geographical locations, each of the regional cache servers being coupled to the at least one data network.

15. A media content delivery system as recited in claim 10, wherein said system further comprises:
a media play system at the retail environment, said media play system configured to play media content pertaining to one or more media items.

16. A media content delivery system as recited in claim 15,
wherein said media play system is configured to play a sequence of media items, and
wherein said media content preload manager operates to preload the media content for the media items within the sequence of media items to said store cache server.

17. A media content delivery system as recited in claim 16, wherein the sequence of media items comprises a playlist of songs that are to be played in the future at the retail environment.

18. A media content delivery system as recited in claim 16, wherein the sequence of media items comprises a playlist of songs that are to be played at the retail environment at least once within the next twenty-four hours.

19. A media content delivery system as recited in claim 16, wherein said media content delivery system is configured to deliver the media content for one or more of the media items within the sequence of media items from said store cache server to a portable media device at the retail environment.

20. A media content delivery system as recited in claim 19, wherein the portable media device is configured to receive and store the media content being delivered for one or more of the media items within the sequence of media items.

21. A media content delivery system as recited in claim 20, wherein the portable media device is configured to purchase the one or more media items before the media content for such is delivered to the portable media device.

22. A media content delivery system as recited in claim 10, wherein the retail environment corresponds to a single retail store.

23. A media content delivery system as recited in claim 10, wherein said media content preload manager is provided at said central server.

24. A media content delivery system as recited in claim 10, wherein the retail environment corresponds to a single retail store associated with a retailer, and wherein said central server is a central retailer server for the retailer.

25. A media content delivery system, comprising:
a store cache server provided at a retail environment;
a media play system at the retail environment, said media play system configured to play media content pertaining to one or more media items, said media play system being configured to play a sequence of media items; and
a media content preload manager operable to preload media content pertaining to the sequence of media items onto said store cache server.
